(19) United States
(12) Patent Application Publication
(10) Pub. No.: US 2014/0003347 A1
(43) Pub. Date: Jan. 2, 2014

(54) REDUCING LATENCY IN CIRCUIT SWITCHED DATA CALLS

(71) Applicants: Markku Juhani Jylhua-Ollila, Helsinki (FI); Jukka Samuli Olkkonen, Helsinki (FI)

(72) Inventors: Markku Juhani Jylhua-Ollila, Helsinki (FI); Jukka Samuli Olkkonen, Helsinki (FI)

(73) Assignee: NOKIA SIEMENS NETWORKS OY, Espoo (FI)

(21) Appl. No.: 13/991,782

(22) PCT Filed: Oct. 28, 2010
(86) PCT No.: PCT/EP2010/066338

§ 371 Date: Sep. 17, 2013

(51) Int. Cl. H04W 40/20; H04W 80/00

(52) U.S. Cl. CPC H04W 40/20; H04W 80/00
USPC 370/328

(57) ABSTRACT

It is provided an apparatus, comprising a receiving means for receiving a request for control of a data call with an analog bearer capability from a calling party which is attached to an originating switching apparatus of an originating circuit switched network wherein the data call is to be routed to a terminating switching device; a determining means for determining a capability of the terminating switching device based on an identification of the terminating switching device; and an originating instruction means for instructing the originating switching apparatus to reserve, for the data call, an originating interworking function for transforming the data call into a data flow of unrestricted digital information if the determined capability corresponds to unrestricted digital information.

### FIELD OF THE INVENTION

The present invention relates to an apparatus, a method, a system, and a computer program product related to circuit switched data calls. More particularly, the present invention relates to an apparatus, a method, a system, and a computer program product for reducing latency in circuit switched data calls.

### BACKGROUND OF THE INVENTION

Due to the reliability and long established experience in usage, circuit switched (cs) data calls are still important in applications where the measurement data must be delivered with high reliability in a cost effective way. These applications are typically telemetry equipment located in power stations, windmills and in various kinds of end user equipment where the measured parameters and statistics data need to be continuously collected. These equipments are furnished with GSM modems and use the basic GSM non transparent (NT) cs data bearer service.

In recent years major operators have started to migrate the mobile core network from a time division multiplex (TDM) based Rel-99 network to the internet protocol (IP) based Release 4 network (MSC Server System). Migration from TDM to IP environment increases the latency in the network which can be drastic to the data calls which are sensitive to excessive round trip delays.

The standard GSM non-transparent data call requires protocol and rate adaptation before it can be delivered over the core network. This functionality is provided by so called interworking function (IWF) which must be used in all mobile originated (MOC) and mobile terminated (MTC) NT cs data calls.

When retrieving data from the telemetry equipment, both the calling and called equipment may be attached to a radio network acting as ordinary GSM terminals. The telemetry equipment may make a data call as an analog NT data call using the Radio Link Protocol (RLP) for correcting the radio path bit errors. The RLP is based on the re-transmission of the corrupted frames. After the interworking function (IWF) in the mobile core network, the call may be transferred using the analog 3.1 kHz audio information transfer capability. Now, when a cs NT data call is used for information delivery between two GSM terminals, there are at the same time two IWFs in the call because the calling side has its own IWF and the called side has its own IWF. The use of two IWFs for one call combined with the IP based release 4 network may cause the round trip delay to increase so much that these telemetry equipment are no longer able to send or receive data.

Changing the telemetry equipment is not a preferred solution because there may be hundreds of thousands pieces of such equipment in the field.

The IWFs may be physically separated from the media gateway (MGW) acting as a switching device. By integrating the IWF equipment in the Release 4 MGW and/or using different IP routes with shorter jitter buffer and packetisation values, minor decreases of the round trip delay may be made.

However, integration of IWFs to every MGW is an expensive solution. Furthermore, using different tighter IP parameters for cs data calls increases the risk of call failure due to the sensitive nature of cs data calls. Additionally the network configuration and routing analyses gets more complicated if data calls need to have separate IP route parameters.

### SUMMARY OF THE INVENTION

It is an object of the present invention to improve the prior art. In particular, it is provided a means and a method, whereby the round trip delay can be significantly decreased in data calls, such as mobile to mobile data calls, without changing the end user equipment (telemetry equipment).

According to a first aspect of the invention, there is provided an apparatus, comprising a receiving means for receiving a request for control of a data call with an analog bearer capability from a calling party which is attached to an originating switching apparatus of an originating circuit switched network wherein the data call is to be routed to a terminating switching device; a determining means for determining a capability of the terminating switching device based on an identification of the terminating switching device; and an originating instruction means for instructing the originating switching apparatus to reserve, for the data call, an originating interworking function for transforming the data call into a data flow of unrestricted digital information if the determined capability corresponds to unrestricted digital information.

In the apparatus, the identification of the terminating switching device may be based on a mobile station roaming number of a called party which is an addressee of the data call.

In the apparatus, the determining means may be configured to determine the capability based on the routing information comprised in the mobile station routing number.

In the apparatus, the identification of the terminating switching device may be received from a home subscriber register.

In the apparatus, the unrestricted digital information may be UDI with V.120 error correction.

In the apparatus, the analog bearer capability may be non-transparent 3.1 kHz audio.

The apparatus may further comprise informing means for providing an information to the terminating switching device about the reservation of the originating interworking function for unrestricted digital information for the data call.

According to a second aspect of the invention, there is provided an apparatus, comprising information receiving means for receiving an information about a reservation of an originating interworking function for an incoming data flow of unrestricted digital information; and terminating instructing means for instructing a terminating switching device of a circuit switched network to reserve, for the incoming data flow, a terminating interworking function for transforming the incoming data flow into a data call with an analog bearer capability.

According to a third aspect of the invention, there is provided an apparatus, comprising a receiving processor for receiving a request for control of a data call with an analog bearer capability from a calling party which is attached to an originating switching apparatus of an originating circuit switched network wherein the data call is to be routed to a terminating switching device; a determining processor for determining a capability of the terminating switching device based on an identification of the terminating switching device; and an originating instruction processor for instructing the originating switching apparatus to reserve, for the data call, an originating interworking function for transforming the data call into a data flow of unrestricted digital information if the determined capability corresponds to unrestricted digital information.

In the apparatus, the identification of the terminating switching device may be based on a mobile station roaming number of a called party which is an addressee of the data call.

In the apparatus, the determining processor may be configured to determine the capability based on the routing information comprised in the mobile station routing number.

In the apparatus, the identification of the terminating switching device may be received from a home subscriber register.

In the apparatus, the unrestricted digital information may be UDI with V.120 error correction.

In the apparatus, the analog bearer capability may be non-transparent 3.1 kHz audio.

The apparatus may further comprise informing processor for providing an information to the terminating switching device about the reservation of the originating interworking function for unrestricted digital information for the data call.

According to a fourth aspect of the invention, there is provided an apparatus, comprising information receiving processor for receiving an information about a reservation of an originating interworking function for an incoming data flow of unrestricted digital information; and terminating instructing processor for instructing a terminating switching device of a circuit switched network to reserve, for the incoming data flow, a terminating interworking function for transforming the incoming data flow into a data call with an analog bearer capability.

According to a fifth aspect of the invention, there is provided a mobile softswitch comprising an apparatus according to any of the first to fourth aspects.

According to a sixth aspect, there is provided a system, comprising an originating control apparatus according to the first aspect, comprising informing means for providing an information to the terminating switching device about the reservation of the originating interworking function for unrestricted digital information for the data call; the originating switching apparatus of the originating control apparatus; a terminating control apparatus according to the second aspect; and the terminating switching device of the terminating control apparatus; wherein the received information of the terminating control apparatus is provided by the informing means of the originating control apparatus; the originating switching apparatus is adapted to reserve the originating interworking function according to the instruction of the originating control apparatus, to handle the data call by the originating interworking function to transform the analog data into a data flow of unrestricted digital information; and to route the data flow of unrestricted digital information to the terminating switching apparatus; and the terminating switching apparatus is adapted to reserve the terminating interworking function for the incoming data flow and to handle the incoming data flow from the originating switching apparatus by the terminating interworking function.

According to a seventh aspect, there is provided a system, comprising an originating control apparatus according to the first aspect, comprising informing processor for providing an information to the terminating switching device about the reservation of the originating interworking function for unrestricted digital information for the data call; the originating switching apparatus of the originating control apparatus; a terminating control apparatus according to the second aspect; and the terminating switching device of the terminating control apparatus; wherein the received information of the terminating control apparatus is provided by the informing processor of the originating control apparatus; the originating switching apparatus is adapted to reserve the originating interworking function according to the instruction of the originating control apparatus, to handle the data call by the originating interworking function to transform the analog data into a data flow of unrestricted digital information; and to route the data flow of unrestricted digital information to the terminating switching apparatus; and the terminating switching apparatus is adapted to reserve the terminating interworking function for the incoming data flow and to handle the incoming data flow from the originating switching apparatus by the terminating interworking function.

In the system according to the sixth or seventh aspect, the originating switching apparatus and the terminating switching apparatus may be connected through an internet protocol based network, and the originating switching apparatus may be configured such that the data flow of unrestricted digital information is routed through the internet protocol based network.

According to an eighth aspect of the invention, there is provided a method, comprising receiving a request for control of a data call with an analog bearer capability from a calling party which is attached to an originating switching apparatus of an originating circuit switched network, wherein the data call is to be routed to a terminating switching device; determining a capability of the terminating switching device based on an identification of the terminating switching device; instructing the originating switching apparatus to reserve, for the data call, an originating interworking function for transforming the data call into a data flow of unrestricted digital information if the determined capability corresponds to unrestricted digital information.

In the method, the identification of the terminating switching device may be based on a mobile station roaming number of a called party which is an addressee of the data call.

In the method, the determining may be based on the routing information comprised in the mobile station routing number.

In the method, the identification of the terminating switching device may be received from a home subscriber register.

In the method, the unrestricted digital information may be UDI with V.120 error correction.

In the method, the analog bearer capability may be non-transparent 3.1 kHz audio.

The method may further comprise providing an information to the terminating switching device about the reservation of the originating interworking function for unrestricted digital information for the data call.

According to a ninth aspect of the invention, there is provided a method, comprising receiving an information about a reservation of an originating interworking function for an incoming data flow of unrestricted digital information; and instructing a terminating switching device of a circuit switched network to reserve, for the incoming data flow, a terminating interworking function for transforming the incoming data flow into a data call with an analog bearer capability.

Each of the methods of the eighth and ninth aspects may be a method of reducing latency.

According to a tenth aspect of the invention, there is provided a computer program product comprising computer-executable components which perform, when the program is run on a computer, the execution of which result in operations of the method according to any of method of the eighth and ninth aspects.

The computer program product may be embodied as a computer-readable storage medium.

Thus, it is provided a way to reduce latency in circuit switched data calls. In some cases, without embodiments of the invention it may be impossible to establish a data call at all.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows an apparatus according to an embodiment of the invention;

FIG. 2 shows a method according to an embodiment of the invention;

FIG. 3 shows a further apparatus according to an embodiment of the invention;

FIG. 4 shows a further method according to an embodiment of the invention; and

FIG. 5 shows a system according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

The telemetry equipment may make a data call as an analog (NT) data call. In the mobile core network, the call may be transferred as an analog 3.1 kHz audio data call. According to embodiments of the invention, data calls, such as telemetry calls, where UDI may be used in the core network, are identified and the protocol between the two IWFs, i.e. for the transmission over the core network, is forced to UDI with V.120 error correction. The data calls may be e.g. mobile to mobile calls.

This solution provides a significant improvement in round trip delay time and ensures the successful operation of telemetry equipment also in IP based Release 4 network.

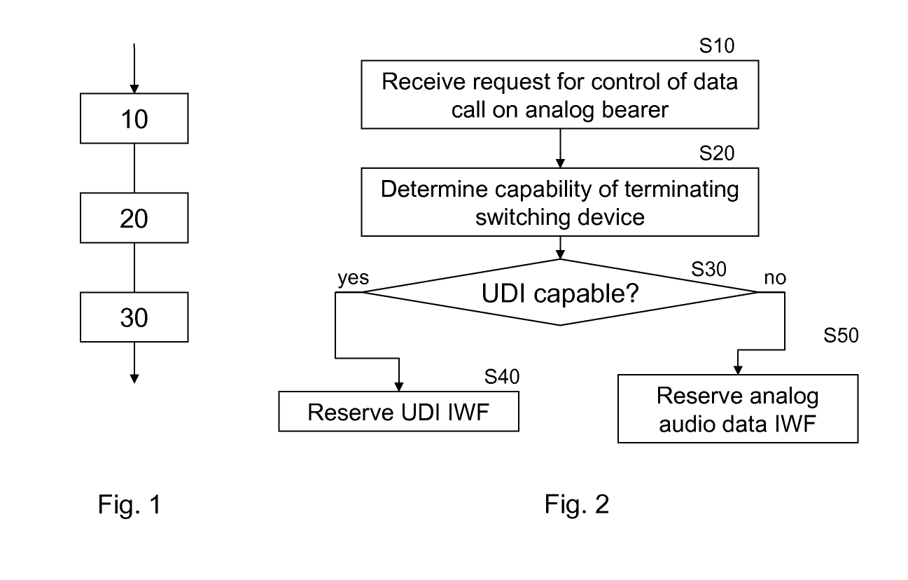

FIG. 1 shows an apparatus according to an embodiment of the invention. The apparatus may be a mobile softswitch (MSS). It comprises a receiver 10, a determiner 20, and an instructor 30. The apparatus may belong to a circuit switched network such as a global system for mobile communication (GSM) network on the originating side of the data call.

FIG. 2 shows a method according to an embodiment of the invention that may be performed by an apparatus such as that shown in FIG. 1.

According to step S10, which may be performed by the receiver 10, a request for control of a data call with an analog bearer capability may be received from a calling party, which is attached to an originating switching apparatus, wherein the data call is directed to a called party attached to a terminating switching device of a terminating circuit switched network. More in particular, a request for call setup is received at the apparatus.

From the request for call setup, the apparatus may determine routing information for the call. In particular, it may receive, e.g. from a home location register (HLR), a mobile station roaming number (MSRN) of the terminating equipment for which the call is intended. The MSRN may comprise a routing information indicating a capability of the terminating switching device (such as a media gateway (MGW) with related interworking function (IWF), or a visited mobile switching center (VMSC)) to which the terminating equipment is attached.

In step S20, which may be performed by the determiner 20, it is determined if the received information about a capability of the terminating switching device indicates that it is capable of interworking with unregistered digital information (UDI) on its network side.

In step S30, it is decided whether or not UDI capability is available in the terminating switch. This decision step may be performed e.g. in the determiner 20, the instructor 30, or in a different means configured to meet such a decision.

If UDI is available on the terminating side (“yes”), in step S40 the MGW is instructed to reserve a UDI IWF for the call. Otherwise (“no”), an analog audio data IWF is instructed to be reserved for the call (step S50). Step S40 and, in some embodiments also step S50, may be performed e.g. by the instructor 30.

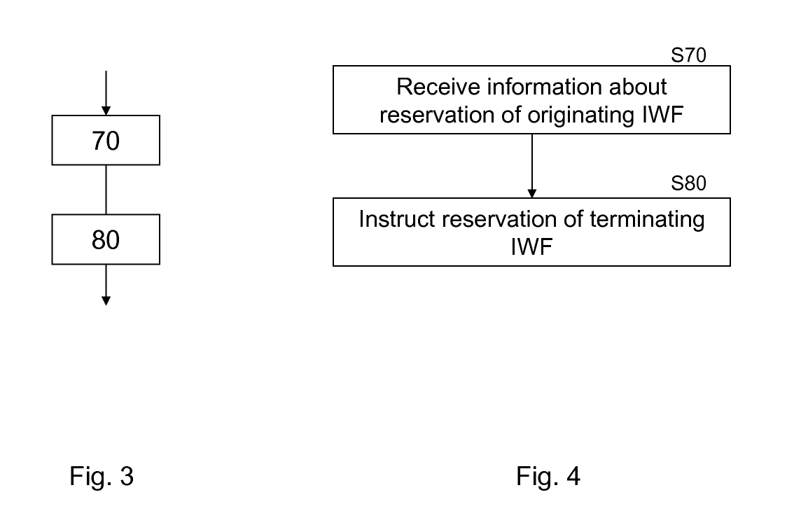

FIG. 3 shows another apparatus according to an embodiment of the invention. This apparatus may be comprised by a mobile softswitch (MSS). It comprises an information receiver 70, and an instructor 80. The apparatus may belong to a circuit switched network such as a global system for communication (GSM) network on the terminating side of the data call.

FIG. 4 shows a method according to an embodiment of the invention that may be performed by an apparatus such as that shown in FIG. 3.

In step S70, an information may be received that UDI is used for the transmission of the data call over the core network. That is, the information receiver 70 may receive an information about “forced UDI” for an incoming data flow. Here, “forced UDI” means that UDI is used for this specific data flow on the network side (the core network).

The instructor 80 may instruct reservation of an UDI interworking function for the network side of the call transforming UDI to analog data bearer capability for the data flow. Such an instruction corresponds to step S80 of the method according to FIG. 4. The analog data bearer capability may depend on the capability of the receiving terminal.

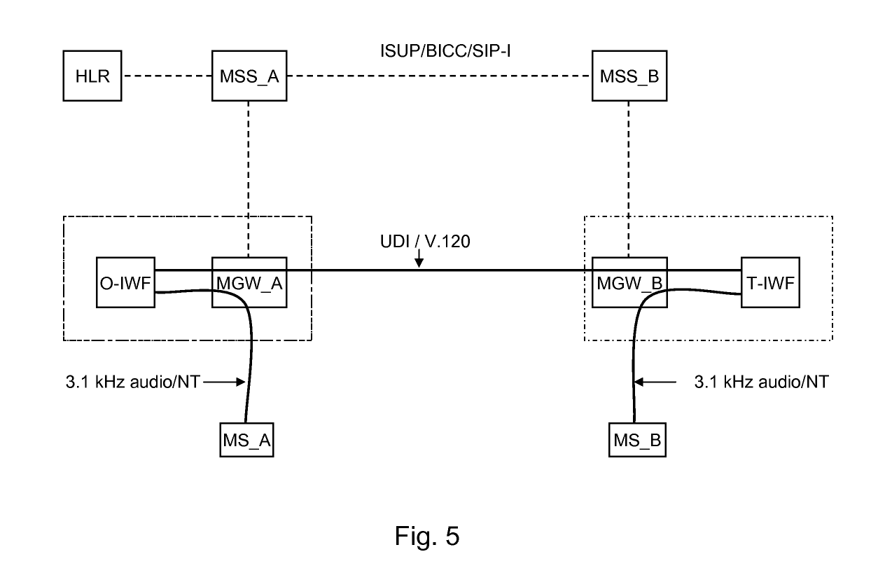

FIG. 5 shows a system according to an embodiment of the invention. In the system, a mobile to mobile data call may be performed from an originating terminal MS_A to a terminating terminal MS_B.

MS_A is attached to media gateway MGW_A (originating side), and MS_B is attached to media gateway MGW_B (terminating side). An originating interworking function (O-IWF) and a terminating interworking function (T-IWF) belong to the media gateways, respectively. The MGWs are controlled by mobile softswitches MSS_A and MSS_B, respectively. MSS_A and MSS_B may exchange control information through e.g. a bearer independent call control (BICC). In other embodiments, instead of BICC, e.g. ISDN user part (ISUP) or session initiation protocol (SIP) may be used. MSS_A is operatively connected to a home location register (HLR) storing current location information of terminal MS_B.

The telemetry equipment (MS_A) making the call sends a request (setup) for control of a data call with an analogue bearer capability. The analysis of the called number is made and, if the call is destined to another mobile (MS_B), then a routing information enquiry will be made at the HLR. MSS_A may defer the IWF selection until the mobile station roaming number (MSRN) is received from the HLR. Next, the MSRN is analysed by MSS_A and, if the call is destined to a media gateway attached to a mobile softswitch, such as MGW_B with MSS_B, that support usage of “forced UDI” on the terminating side, the MSS_A will reserve IWF resources for the calling party so that network side connection uses UDI with V.120.

MSS_A informs the terminating side MSS_B on “forced UDI”. This may be performed by any means supported by the signalling like adding a prefix in front of the called number or by using a subscriber category etc. MSS_B on the called side may send a SETUP with analog 3.1 kHz NT bearer capability to the MS_B and reserve network side IWF resources with UDI/V.120.

Thus, the call may have non-transparent (NT) radio link protocol (RLP) cs data legs between the terminals (MS_A, MS_B) and the respective IWFs, and forced UDI /V.120 connection between the IWFs. The round trip delay for such a call is considerably reduced compared to that where analogue bearer capability is used between the IWFs. In some embodiments, where the round trip delay was excessive large with analogue bearer capability, this configuration may even re-establish the option of making data calls at all.

Hereinabove, some embodiments of the invention are explained with respect to a mobile to mobile data call in a GSM network. However, in other embodiments, the terminating network side may be another circuit switched network. E.g. the terminating side may be an ISDN network with an ISDN terminal.

In cases like ISDN as terminating network, where the originating softswitch does not receive an MSRN of the receiving side, from which it may determine the capability for UDI of the terminating side, a specific number range may be reserved for such mobile originated data calls ending in the ISDN, where the terminating switch may accept UDI. Correspondingly, a data call may be transformed into UDI by the originating switch, if the terminal phone number is within the specified number range.

Furthermore, the invention is not restricted to GSM as originating network but may be related to any circuit switched mobile or fixed network, such as ISDN.

The originating and the terminating networks may be the same or different networks. Networks are different if, for example, they have different identifications like country code (CC) and/or national destination code (NDC), or if they belong to a different technology.

In some embodiments, additionally to determining whether or not UDI capability is present on the terminating switch, it may be determined whether a capability of V.120 error correction is available, and the decision to transform into UDI may additionally depend on the support of V.120 error correction.

In some embodiments, the method of the present invention is applied to predefined originating terminals only, which may be identified based on their subscription (e.g. their MSISDNs). Thus, the overall performance of the originating MSS_A may be improved at the cost of administrative work to predefine the concerned terminals.

If not otherwise stated or otherwise made clear from the context, the statement that two entities are different means that they are differently addressed in their communication network, or that they belong to different communication networks. It does not necessarily mean that they are based on different hardware. That is, each of the entities described in the present description may be based on a different hardware, or some or all of the entities may be based on the same hardware.

The invention is not limited to softswitches and media gateways with related interworking functions, where transport and control are separated. In some embodiments of the invention, switching equipment such as a mobile switching center (MSC), where transport and control are fully or partly integrated, may be used.

According to the above description, it should thus be apparent that exemplary embodiments of the present invention provide, for example, a control function such as a mobile softswitch, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. Apparatus, comprising
a receiving means for receiving a request for control of a data call with an analog bearer capability from a calling party which is attached to an originating switching apparatus of an originating circuit switched network wherein the data call is to be routed to a terminating switching device;
a determining means for determining a capability of the terminating switching device based on an identification of the terminating switching device; and
an originating instruction means for instructing the originating switching apparatus to reserve, for the data call, an originating interworking function for transforming the data call into a data flow of unrestricted digital information if the determined capability corresponds to unrestricted digital information.

2. The apparatus according to claim 1, wherein the identification of the terminating switching device is based on a mobile station roaming number of a called party which is an addressee of the data call.

3. The apparatus according to claim 2, wherein the determining means is configured to determine the capability based on the routing information comprised in the mobile station routing number.

4. The apparatus according to claim 1, wherein the identification of the terminating switching device is received from a home subscriber register.

5. The apparatus according to claim 1, wherein the unrestricted digital information is UDI with V.120 error correction.

6. The apparatus according to claim 1, wherein the analog bearer capability is non-transparent 3.1 kHz audio.

7. The apparatus according to claim 1, further comprising
informing means for providing an information to the terminating switching device about the reservation of the originating interworking function for unrestricted digital information for the data call.

8. An apparatus, comprising
information receiving means for receiving an information about a reservation of an originating interworking function for an incoming data flow of unrestricted digital information; and
terminating instructing means for instructing a terminating switching device of a circuit switched network to reserve, for the incoming data flow, a terminating interworking function for transforming the incoming data flow into a data call with an analog bearer capability.

9. A mobile softswitch comprising an apparatus according to claim 1.

10. A system, comprising
an originating control apparatus comprising
a receiving means for receiving a request for control of a data call with an analog bearer capability from a calling party which is attached to an originating switching apparatus of an originating circuit switched network wherein the data call is to be routed to a terminating switching device;
a determining means for determining a capability of the terminating switching device based on an identification of the terminating switching device;
an originating instruction means for instructing the originating switching apparatus to reserve, for the data call, an originating interworking function for transforming the data call into a data flow of unrestricted digital information if the determined capability corresponds to unrestricted digital information; and
informing means for providing an information to the terminating switching device about the reservation of the originating interworking function for unrestricted digital information for the data call;
the originating switching apparatus of the originating control apparatus;
a terminating control apparatus comprising
information receiving means for receiving an information about a reservation of an originating interworking function for an incoming data flow of unrestricted digital information; and
terminating instructing means for instructing a terminating switching device of a circuit switched network to reserve, for the incoming data flow, a terminating interworking function for transforming the incoming data flow into a data call with an analog bearer capability; and
the terminating switching device of the terminating control apparatus; wherein
the received information of the terminating control apparatus is provided by the informing means of the originating control apparatus;
the originating switching apparatus is adapted to reserve the originating interworking function according to the instruction of the originating control apparatus, to handle the data call by the originating interworking function to transform the analog data into a data flow of unrestricted digital information; and to route the data flow of unrestricted digital information to the terminating switching apparatus; and
the terminating switching apparatus is adapted to reserve the terminating interworking function for the incoming data flow and to handle the incoming data flow from the originating switching apparatus by the terminating interworking function.

11. The system according to claim 10, wherein the originating switching apparatus and the terminating switching apparatus are connected through an internet protocol based network, and wherein the originating switching apparatus is configured such that the data flow of unrestricted digital information is routed through the internet protocol based network.

12. Method, comprising
receiving a request for control of a data call with an analog bearer capability from a calling party which is attached to an originating switching apparatus of an originating circuit switched network, wherein the data call is to be routed to a terminating switching device;
determining a capability of the terminating switching device based on an identification of the terminating switching device;
instructing the originating switching apparatus to reserve, for the data call, an originating interworking function for transforming the data call into a data flow of unrestricted digital information if the determined capability corresponds to unrestricted digital information.

13. The method according to claim 12, wherein the identification of the terminating switching device is based on a mobile station roaming number of a called party which is an addressee of the data call.

14. The method according to claim 13, wherein the determining is based on the routing information comprised in the mobile station routing number.

15. The method according to claim 12, wherein the identification of the terminating switching device is received from a home subscriber register.

16. The method according to claim 12, wherein the unrestricted digital information is UDI with V.120 error correction.

17. The method according to claim 12, wherein the analog bearer capability is non-transparent 3.1 kHz audio.

18. The method according to claim 12, further comprising
providing an information to the terminating switching device about the reservation of the originating interworking function for unrestricted digital information for the data call.

19. A method, comprising
receiving an information about a reservation of an originating interworking function for an incoming data flow of unrestricted digital information; and
instructing a terminating switching device of a circuit switched network to reserve, for the incoming data flow, a terminating interworking function for transforming the incoming data flow into a data call with an analog bearer capability.

20. A computer program product, embodied on a computer-readable storage medium, the computer program product comprising computer-executable components which perform, when the program is run on a computer, the execution of which result in operations of the method according to claim 12.

21. (canceled)
